(19) United States
(12) Patent Application Publication
(10) Pub. No.: US 2013/0270039 A1
(43) Pub. Date: Oct. 17, 2013

(54) MECHANICAL MOTION SYSTEM FOR ENERGY GENERATION

(71) Applicant: Renato Ribeiro, Puerto Alegre (BR)

(72) Inventor: Renato Ribeiro, Puerto Alegre (BR)

(21) Appl. No.: 13/797,884

(22) Filed: Mar. 12, 2013

Related U.S. Application Data
(60) Provisional application No. 61/618,451, filed on Mar. 30, 2012.

(30) Foreign Application Priority Data
Mar. 30, 2012 (BR) 10 2012 007288 2

(51) Int. Cl. F03G 3/06

(52) U.S. Cl. CPC F03G 3/06; F03G 7/10
USPC 185/29; 74/DIG. 9

(57) ABSTRACT

Objective—Create a mechanical system to manage the gravitational force exerted on a series of weights; with the ultimate goal of transferring this force to turn a shaft. The system consists of a fixed base and 2 types of mechanical modules. The modules are arranged side-by-side along a crankshaft. One module type consists of rods connected to a crankshaft. Two arms are connected to the fixed structure and to a third arm. All are connected to a central shaft by a connecting rod. A second type of module consists of a support arm for the weight connected to the central axis. The length of the support arm is variable. The arm is held in position by a pin which is pulled at the precise moment; altering the length of the arm. This shifts the center of gravity and drives the crankshaft. The altering of the arms' lengths is synchronized.

### RELATED APPLICATION

This application relates to and claims priority from U.S. Provisional Application 61/618,451 filed Mar. 30, 2012, entitled SYSTEM FOR THE PRODUCTION OF ENERGY AND EQUIPMENT FOR SUCH PRODUCTION, still pending, and is a continuation-in-part of U.S. Utility application Ser. No. 13/757,488 filed Feb. 1, 2013, still pending. The contents of these applications are incorporated by reference herein in their entirety.

### INITIAL CONSIDERATIONS

This application for patent registration is similar to my previous application called “SYSTEM FOR THE PRODUCTION OF ENERGY AND EQUIPMENT FOR SUCH PRODUCTION” dated Mar. 30, 2012 under number BR 10 2012 007288 2, and my U.S. Utility application Ser. No. 13/757,488 filed Feb. 1, 2013; however, it is different. They are separate and independent applications. In my previous applications, the weight occurs over a rail while in this application the weight is fixed to the end of a bar. In both cases, the arrangement that surrounds a support structure, the crankshaft, the positive and neutral bars the same. The arc-lock system and placement of the locks to enable the weight to be supported on one or the other bar, positive or neutral at the convenient time is also the same. In both cases the lock and be placed and removed to manage the existing gravity energy on the weight.

The present disclosure relates to continuous and perpetual mechanical motion for energy production exclusively powered by the force or energy of gravity.

### FIELD OF INVENTION

The present invention is in the area of energy production but focused on and with the objective of obtaining this generation by only using the energy of gravity. When we think of exclusively using force of gravity to power the system, and when this force is present at any place and at any time and is constant, we are not referring to perpetual motion that will work forever while the mechanical equipment that makes up the system lasts. This would be the greatest innovation of recent times. It would promote a huge change in the world that will be referred to before and after this invention.

### DESCRIPTION OF RELATED ARTS

For centuries the industrial development and global population growth have been demanding the availability of more energy. Formerly, energy was obtained from firewood and coal, which supplied the energy necessities of the world for a long period of time. For a long time we also had the use of windmills that were replaced by an easier and cheaper means at the time, which was oil and this way these sources were developed till present. We continue to burn firewood and coal and this developed into the burning of other types of wastes. When oil became expensive, the use of windmills returned and this also resulted in the use of solar energy. Recently we have the use of fats in general that are transformed into diesel. The continuous increasing need for energy is also forcing the development of other smaller sources of energy. Our field of invention is based on this history of energy, in search of new sources of energy.

In the last centuries thousands of attempts have been made to create a form of using gravity. Major values were invested with this purpose all over the world without obtaining results. For a long time in past centuries the English government offered a large amount as reward for whoever created the then called continuous motion.

### OBJECTION OF THE INVENTION

Therefore, the objective of the present invention is to create a system to produce energy as well as the equipment necessary only using the planet's gravity as source of energy. To achieve the objective above, we developed a conception of different types of motions made up of a crankshaft and mechanical bars making up assemblies. Furthermore, these assemblies were placed side by side. In this case there is a 45 degrees lag between them. The movements of each assembly are combined and synchronized. Finally, each assembly has a bar on which a fixed weight is supported. This bar is supported on the positive or neutral bars through mobile locks that are placed or removed at the appropriate time.

### DRAWINGS

FIG. 1 shows a colored perspective view of an equipment completely built to incorporate an illustrative concretization of the system according to the present invention;

FIG. 2 shows a view in technical lines of the equipment shown in FIG. 1;

FIG. 3 shows a view similar to FIG. 1, where only one of the motion assemblies of the system is highlighted, according to the illustrative concretization of the invention;

FIG. 4 shows a view in technical lines of the equipment shown in FIG. 3;

FIG. 5 shows a view similar to that shown in FIG. 2, highlighting the dimension of a model of the equipment;

FIG. 6 shows a view similar to that shown in FIG. 4, highlighting the dimensions of the component parts of a model of the equipment;

FIG. 7 shows a detailed view of the components of one of the motion assemblies of the system according to the illustrative concretization of the present invention (central shaft);

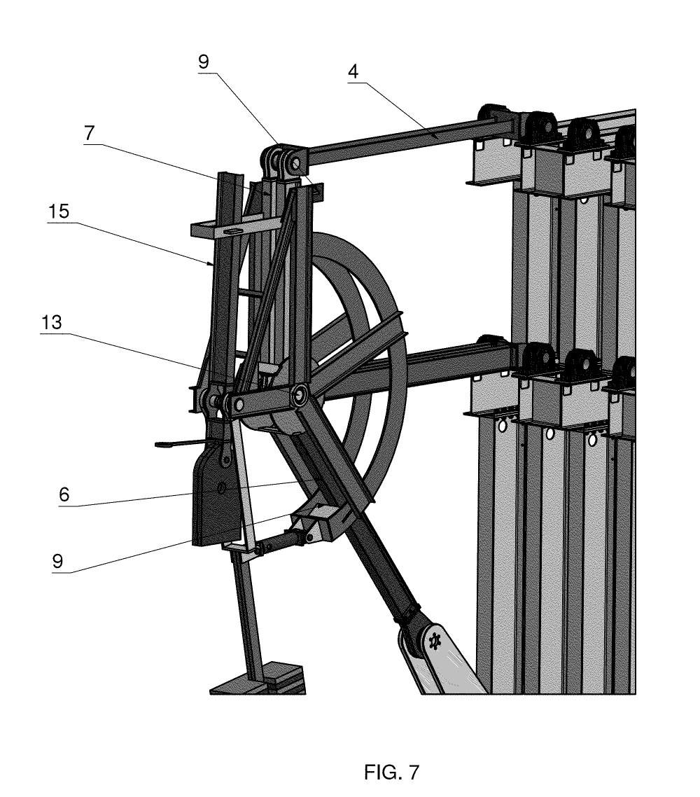

FIG. 8 shows a view in technical lines of the equipment shown in FIG. 7;

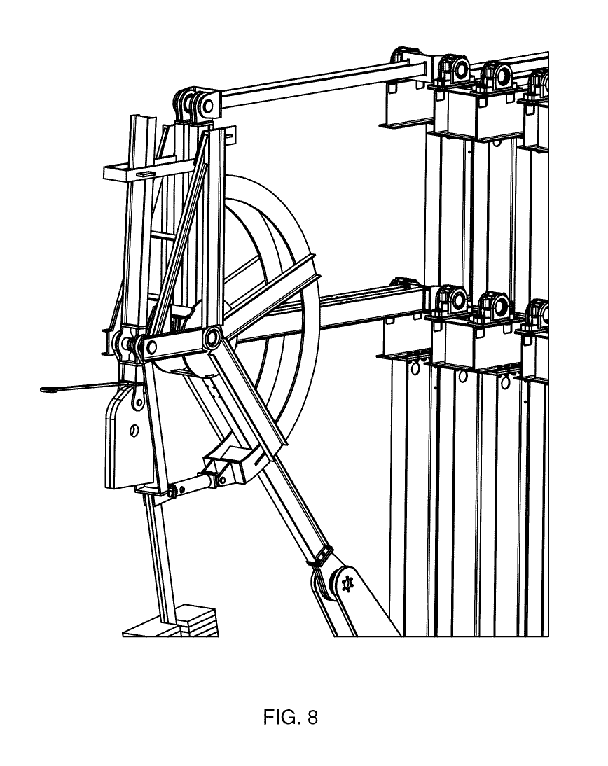

FIG. 9 shows a side view of the first of the motion assemblies of the system according to the illustrative concretization of the present invention (angle of the crankshaft ZERO degree, and locks);

FIG. 10 shows a view in technical lines of the assembly shown in FIG. 9;

FIG. 11 shows a side view of the second of the motion assemblies of the system according to the illustrative concretization of the present invention (angle of the crankshaft 45° degree, and locks);

FIG. 12 shows a view in technical lines of the assembly shown in FIG. 11;

FIG. 13 shows a side view of the third of the motion assemblies of the system according to the illustrative concretization of the present invention (angle of the crankshaft 90° degree, and locks);

FIG. 14 shows a view in technical lines of the assembly shown in FIG. 13;

FIG. 15 shows a side view of the fourth of the motion assemblies of the system according to the illustrative concretization of the present invention (angle of the crankshaft 135° degree, and locks);

FIG. 16 shows a view in technical lines of the assembly shown in FIG. 15;

FIG. 17 shows another side view of the fourth of the motion assemblies of the system according to the illustrative concretization of the present invention (angle of the crankshaft 149° degree, and locks);

FIG. 18 shows a view in technical lines of the assembly shown in FIG. 17;

FIG. 19 shows a side view of the motion assemblies shown in FIG. 18;

FIG. 20 shows a perspective view of a double equipment that incorporates two systems according to the illustrative concretization of the present invention;

FIG. 21 shows a view in technical lines of the equipment shown in FIG. 20;

FIG. 22 illustrates two crankshafts used in the equipment shown in FIG. 21; and

FIG. 23 shows a view in technical lines of the crankshafts shown in FIG. 22.

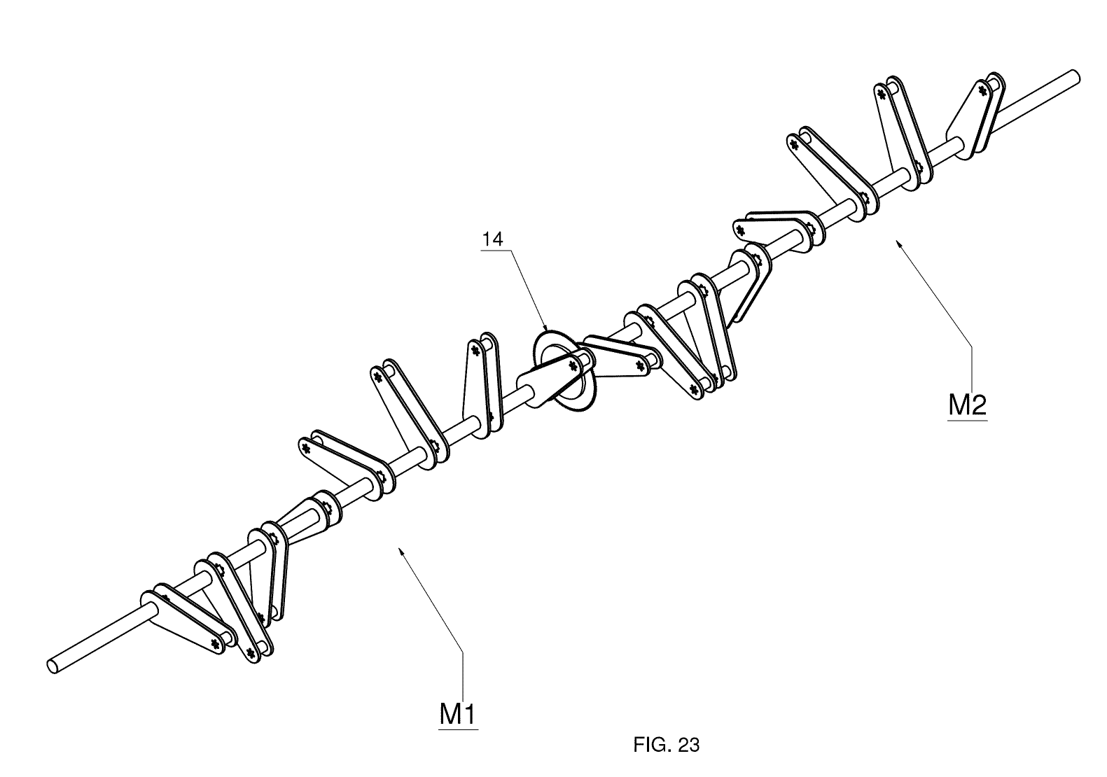

LIST OF NUMERICAL REFERENCES USED IN THE DRAWINGS

| Component | Reference number |
|---|---|
| Motion assemblies or arrangements | 1 |
| Support structure | 2 |
| Weight support bar | 3 |
| Green positive bar | 4 |
| Green positive bar | 5 |
| Blue positive bar | 6 |
| Neutral bar | 7 |
| Weight | 8 |
| Arc-locks | 9 |
| Locks | 10 |
| Telescopic arm with mobile latching | 10-A |
| Arm adjustable tilt of the arm weight | 10-B |
| Crankshaft | 11 |
| Crankshaft arm | 12 |
| Central shaft | 13 |
| Transmission gear | 14 |
| Support arm of the moveable weight | 15 |
| Arm tilt control of the moveable weight arm | 16 |
| Machines of the double equipment | M1, M2 |

### DETAILED DESCRIPTION OF THE INVENTION

An exclusively mechanical system was created made up of common market materials and parts such as a support structure built with metallic beams, a crankshaft, metallic bars connected to one another through rollers or supported to one another and a weight made of steel plates.

It was planned and designed to mount these parts with an arrangement made up of assemblies and place these assemblies side by side connected to each crankshaft arm.

This arrangement was designed with two specific and fundamental functions. The first to enable the transfer of energy from the force of gravity existing on the weight support bar and the weight itself through the positive or neutral bars and the central shaft going up to the crankshaft arm, generating a torque on its shaft.

The second function is to enable the choice of the bar on which the weight support bar and the weight itself will be supported, through placement or removal of the locks on the support arc-locks. We can choose between placing and removing the lock of the telescopic arm. It also enables the choice of moment and time when this support remains effective.

The value of the force of gravity existing on the weight support bar and the weight itself, when they are supported on the neutral bar, is always the same, independent of the point where the weight is connected to the weight support bar. Therefore, with the weight hanging on the central shaft or on the end of the weight support bar, the value of the force of gravity that drives the central shaft will always be the same.

The value of the force of gravity existing on the weight support bar and the weight itself, when these are supported on the green positive bar, is added or increased by a proportional value between the length of the green positive bar and the weight support bar, and therefore, the value of the force of gravity that arrives at the central shaft is added or increased. In the equipment presented in the drawings, the length of the green positive bars is 4-fold the weight support bar and, in this case, the value of the force of gravity that arrives at the central shaft is 25% greater, or two times greater than the force of gravity existing on the weight. When the support is in the blue bar, the additional force can be negative or positive, depending on the angle of the crankshaft.

In this presentation, the weight support bar and the weight itself were supported only on the yellow neutral bar and on the blue positive bar. When the support of the weight support bar and the weight itself are on the blue bar, a positive force will be generated and the crankshaft will be driven at a permanent and eternal motion.

Finally, this equipment, when concluded and built, must be locked. When unlocked, the crankshaft will turn and continue to turn forever.

The presented equipment is built exclusively mechanical, using common material existing in the market. We use beams and angle brackets, cut and rolled steel plates, worked to make up isolated assemblies, placed side by side to work in sequence.

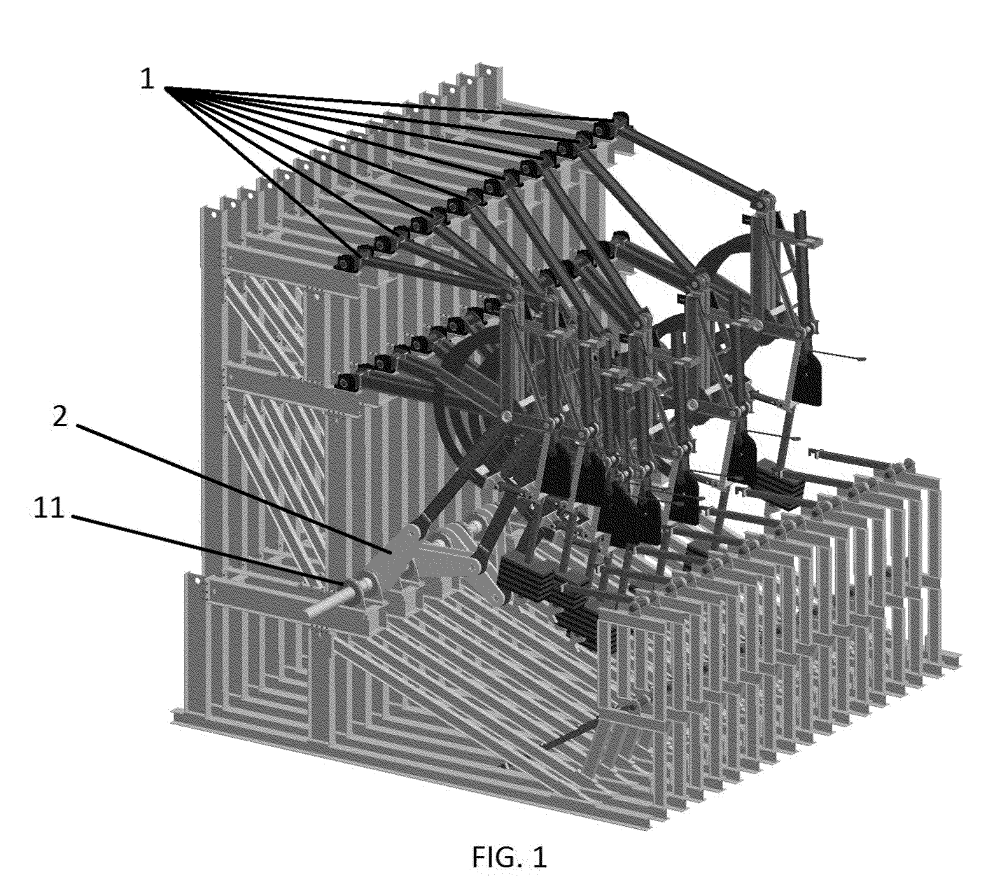

The invention consists in the conception and creation of an assembly where there are bars with positive force and a bar with neutral force. Besides these bars there is another bar over which the weight is placed. This bar is connected to the system made up of an arc where the locks are placed. These locks have the purpose and objective of connecting the weight bar with one of the other four bars in the convenient position and also in the suitable time to enable the use of the force of gravity. To achieve this objective, I built a prototype machine where I conducted these force tests. FIG. 1 shows the complete assembly of the force testing equipment, where I could prove the existence of a force other than gravity, and could capture this force and make it available through a torque on the crankshaft. I am now building two new equipments, bigger in size, one in Porto Alegre—Brasil, at avenida Pátria, 195 and the other in Gilmam, Ill.—United States, at the industrial plant of Incobrasa Ltda. They will be demonstration models and will each produce 30 KW. These equipments do not produce any type of pollution, noise or heat.

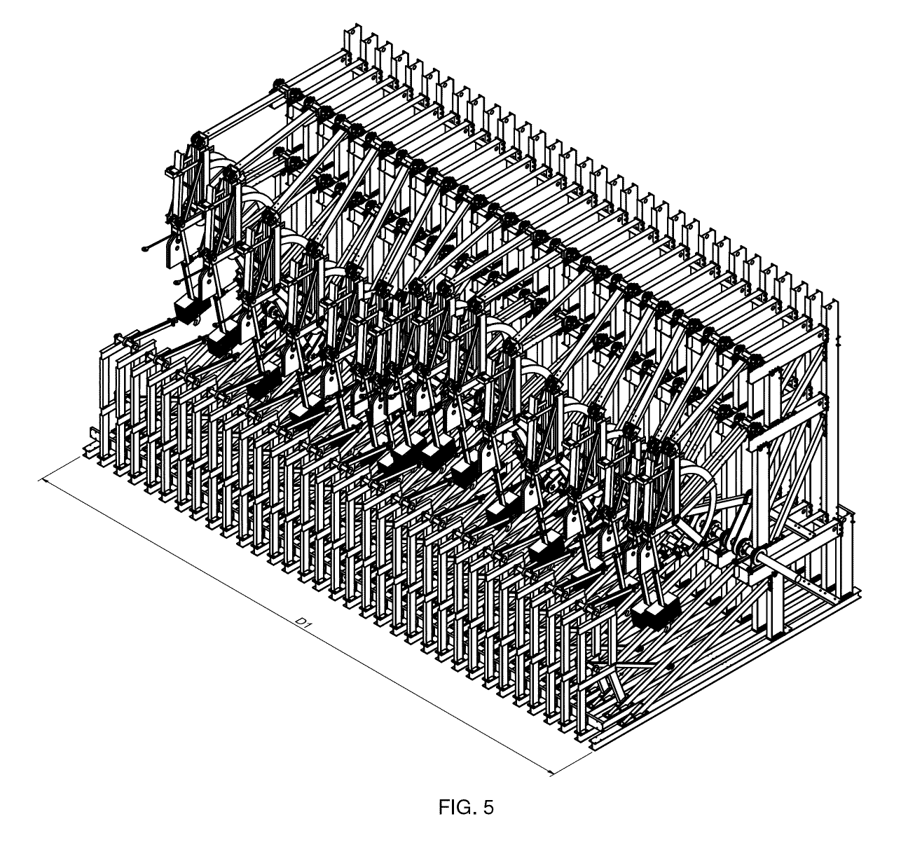

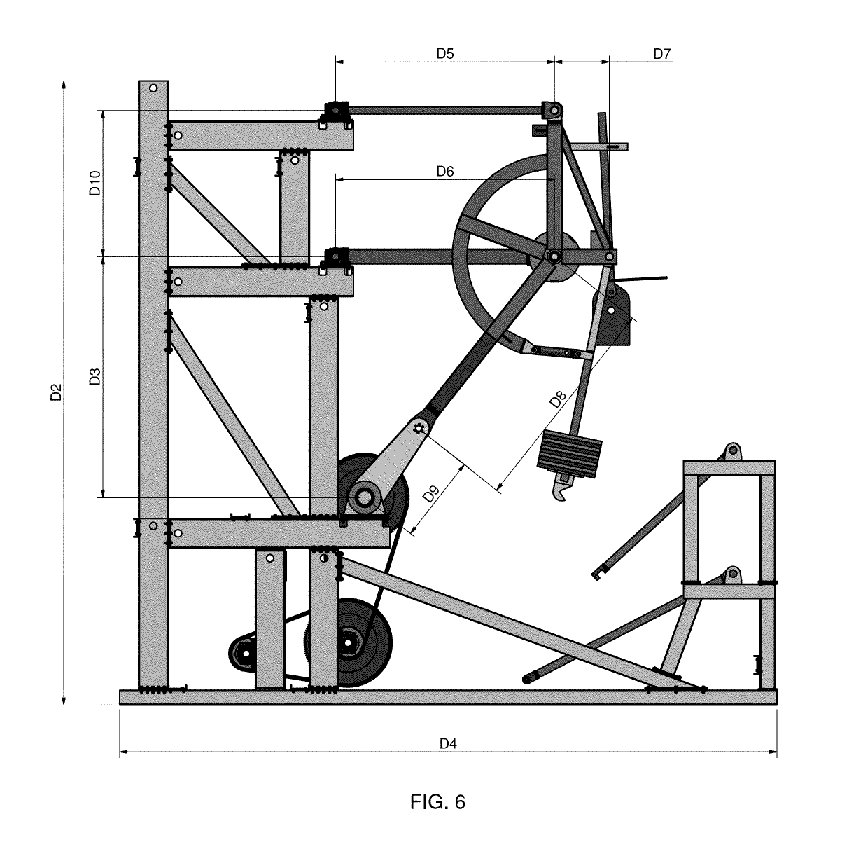

FIGS. 5 and 6 show the dimensions of the components of the equipment according to the illustrative concretization of the present invention. However, it must be understood that these dimensions may be changed to achieve specific yields, according to the necessities of the design to be developed.

The table below shows the dimensions highlighted in the figures.

TABLE 1
Dimensions of the equipment according to the illustrative
concretization of the present invention.

| | Dimension | Dimension |
|---|---|---|
| Component | reference | (mm) |
| Support structure 2 (length) | D1 | 17337 |
| Support structure 2 (height) | D2 | 8542 |
| Support structure 2 (height crankshaft support/ | D3 | 3298 |
| weight bar support) | | |
| Support structure 2 (width) | D4 | 9000 |
| Positive bars 4, 5 | D5/D6 | 3000 |
| Weight support bar 3 | D7 | 3000 |
| Positive bar 6 | D8 | 3000 |
| Arm 12 of crankshaft 11 | D9 | 1200 |
| Neutral bar 7 | D10 | 2000 |

The presented equipment and the one being built with the measures indicated in FIGS. 5 and 6 are designed for a weight of 1,000 kg. With this weight, the equipment can produce a value greater than 30 KW of the generator that is being placed and, therefore, the weight that will finally be used will be that necessary to generate 30 KW.

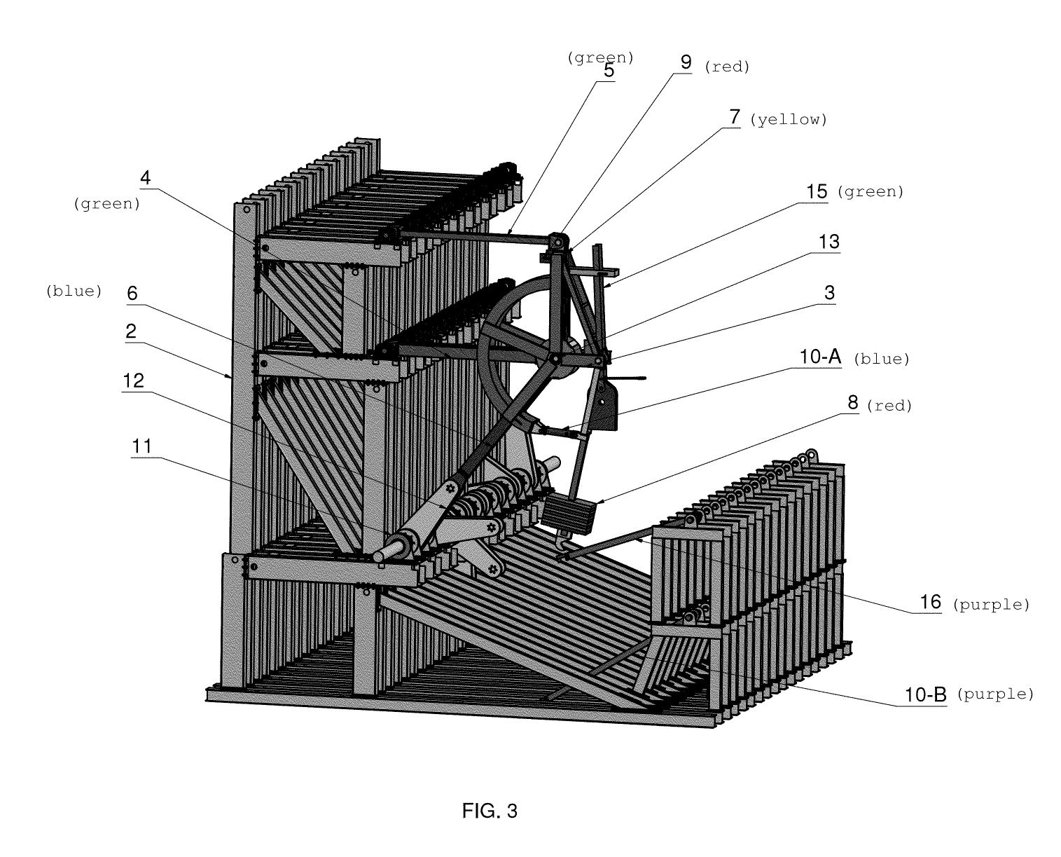

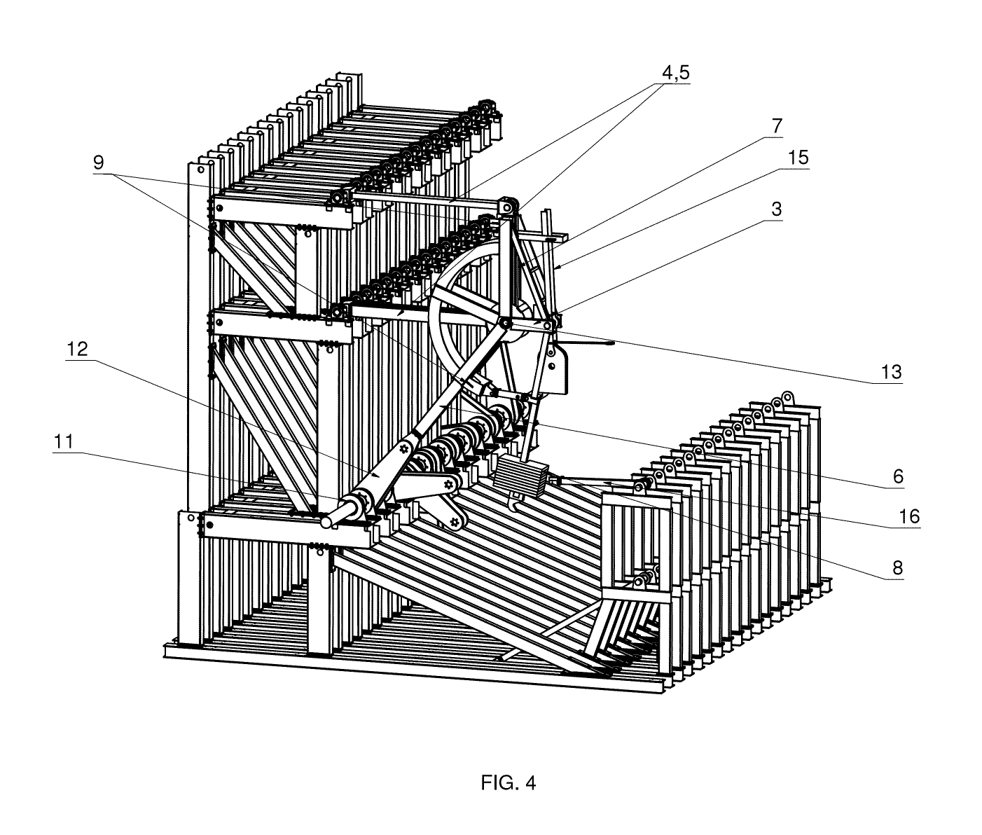

In FIGS. 3 and 4, we presented only the first assembly of bars with their denominations. We also presented the bar that supports the weight, the arc that supports the locks, the support arms of weights, the arms that control the tilt of the weights and the crankshaft. Let us then denominate as angle ZERO the initial motion point to be presented, and that in FIGS. 3 and 4 show the arm of the crankshaft aligned with the positive blue bar. From this point, the motion will be clockwise. From now on we can call the bars only blue, green and yellow, as well as weight support bar and crankshaft arm. The figure shows that the green bars are connected at a fixed point of the structure and also to the yellow bar. They are mounted in a way that during the entire motion the yellow bar always remains in the vertical position. This yellow bar is connected to the blue bar and the blue bar will transmit the force from the crankshaft arm. We can also see that the weight support bar is connected in a fixed manner to the arc-locks, as seen in FIGS. 5 and 6. This weight support bar and the arc-locks are mounted on the same shaft that are mounted to the yellow, blue and green bar but are not fished to any of these bars. The weight support bar, through the arc-locks, only supports itself on one of the other bars as the locks fixed to the arc-locks is placed or removed, according to the convenience to obtain the desired results.

The force of gravity exerted over the weight is transferred to the assembly through the central shaft. This shaft, depending on where the locks are exercising the support, if they are on the positive or neutral arms and when, transfer more or less force to the blue bar. This in turn transfers the force to the crankshaft arm that is transferred to the crankshaft where the torque is applied.

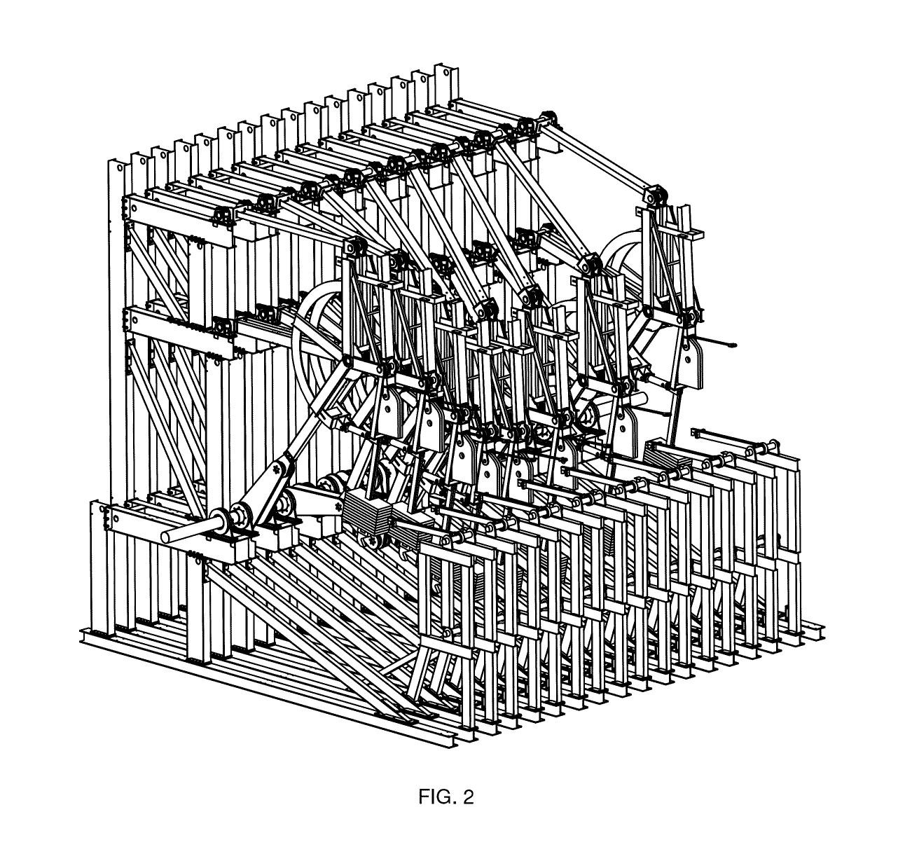

The arrangement shown in FIGS. 1, 2, 3 and 4 involving a support structure, a crankshaft, an assembly of interconnected arms, on the support structure and on the crankshaft and the weight that hangs on the weight support bar was specially designed and created with the objective and purpose of making it possible to work and manage the effects of the force of gravity that exists on the entire assembly and especially on the weight. By choosing the radius of the crankshaft, the length of the arms and the angles, I am mounting a mechanical system that allows me to manage how the effects of gravity occur. This arrangement then has the specific function of making it possible to choose how the force of gravity will transmit piece by piece to the crankshaft. It also allows me to choose through the placement or removal of locks where I support the weight support bar and the weight itself, which can be on the positive green bar, positive blue bar or on the neutral yellow bar. The function of removing and placing the locks on the convenient bar and at the convenient time is of extreme important to manage the force of gravity. Also, when I choose at which crankshaft angles the weight support bar is supported, that is, how long they remain supported on one or another bar, I am managing the force of gravity existing on the entire assembly and especially on the weight.

A fundamental part of the invention is the arrangement that was designed and created to enable handling the force of gravity existing on the weight support bar and the weight itself. The change in proportion of dimensions between each piece of the arrangement can improve the yield of the invention, but the important thing is the formation of the arrangement that creates the possibility of choosing how to transfer the force of gravity that exists on the weight support arm and on the weight to the crankshaft.

Another fundamental part is the function of the locks that can be placed and removed to choose the exact moment and period when they should be supported on one or another positive or neutral bar.

Shown below is the influence of the forces of gravity when the weight bar is supported on one of the other blue, green or yellow bars.

1—When the weight bar and the weight itself are supported on the yellow neutral bar through the lock that is placed on the support arc of the locks, the force of gravity exerted on the weight will always be the same and will have the same value anywhere on the support bar where the weight is hanged from. Therefore, the value of the force of gravity that the weight support bar transfers to the central shaft is exactly the same. Hence, everything occurs as if the weight was hanging from the central shaft, even if it is really hanging from the central shaft or from the tip of the weight support bar as shown in the drawing. At any point of the assembly motion, that is, turning the crankshaft 360 degrees, the weight support bar will remain in the horizontal position. This is because the yellow neutral bar always remains in the vertical position. When connected to this bar, the weight support bar consequently remains in the horizontal position. With all the eight weight bars supported on the yellow neutral bar, the equipment will be balanced. It moves freely with any impulse and stops at any point.

2—When the weight bar and the weight itself are supported on the green positive bar through the lock placed on the support arc locks, the force of gravity exerted on the bar and weight that transfers to the central shaft have an additional force of proportional value between the length of the weight support bar and the green positive bar. Therefore, the length of the weight support bar on the equipment shown in FIGS. 1, 2, 3 and 4 the length of the weight support bar is ¼ of [the length of] the positive green bar upon which it lies on. Hence, the force of gravity transmitted to the central shaft increases by 25% of the existing force of gravity on the weight. Whenever the weight bar remains supported on the green positive bar, it will incline in the same angle and direction of the green positive bar. When the assembly leaves angle zero of the crankshaft in the clockwise direction, the weight support bar inclines to the assembly, achieving the lowest point. From the lowest point to the highest point, the weight support bar will incline in the anticlockwise direction and when the crankshaft reaches angle zero the weight support bar will again be in the horizontal position. It is worth emphasizing that the force of gravity existing on the central shaft and its addition is transmitted to the crankshaft through the blue positive bar and depending on the angle of the crankshaft arm, the force will be proportional to the this angle. Therefore, there is a force variation for low and high for each position existing between the crankshaft arm and the blue positive bar.

3—When the weight bar and the weight itself are supported on the blue positive bar, there is a much more complex and complicated situation in comparison to the support on the yellow neutral or green positive bar. Regarding the force of gravity existing on the weight support bar and the weight, this force will also have an increase or an additional force when this force is transferred to the central shaft, in the same way it occurs and has already been described when the support is on the green positive bar. That is, both on the green positive bar and the blue positive bar, the force of gravity transmitted to the central shaft is proportional to the length of the bars. However, when the force of the central shaft is transmitted to the crankshaft arm through the blue positive bar, a very complex and complicated formation of forces occurs, as already mentioned.

Starting from angle zero of the crankshaft in the clockwise direction, there will be a negative force that will reduce as the crankshaft arm moves. During this initial motion, the weight support bar will incline in the same direction of the blue positive bar. After a certain period as the crankshaft moves, the positive blue bar inverts its movement of inclination and consequently the weight support bar also inverts its movement of inclination. Furthermore, the resulting forces of the inclination of the blue positive bar in relation to the crankshaft arm changes in a very complicated manner. Hence, when the crankshaft begins its movement with the arm on angle zero, this arm is subject to a negative force that reduces to the point of equilibrium and then increases. All this highly complicated force transmission motion that occurs when the weight support arm is supported on the blue positive bar will be better understood below during detailing of the operation.

### SUMMARY

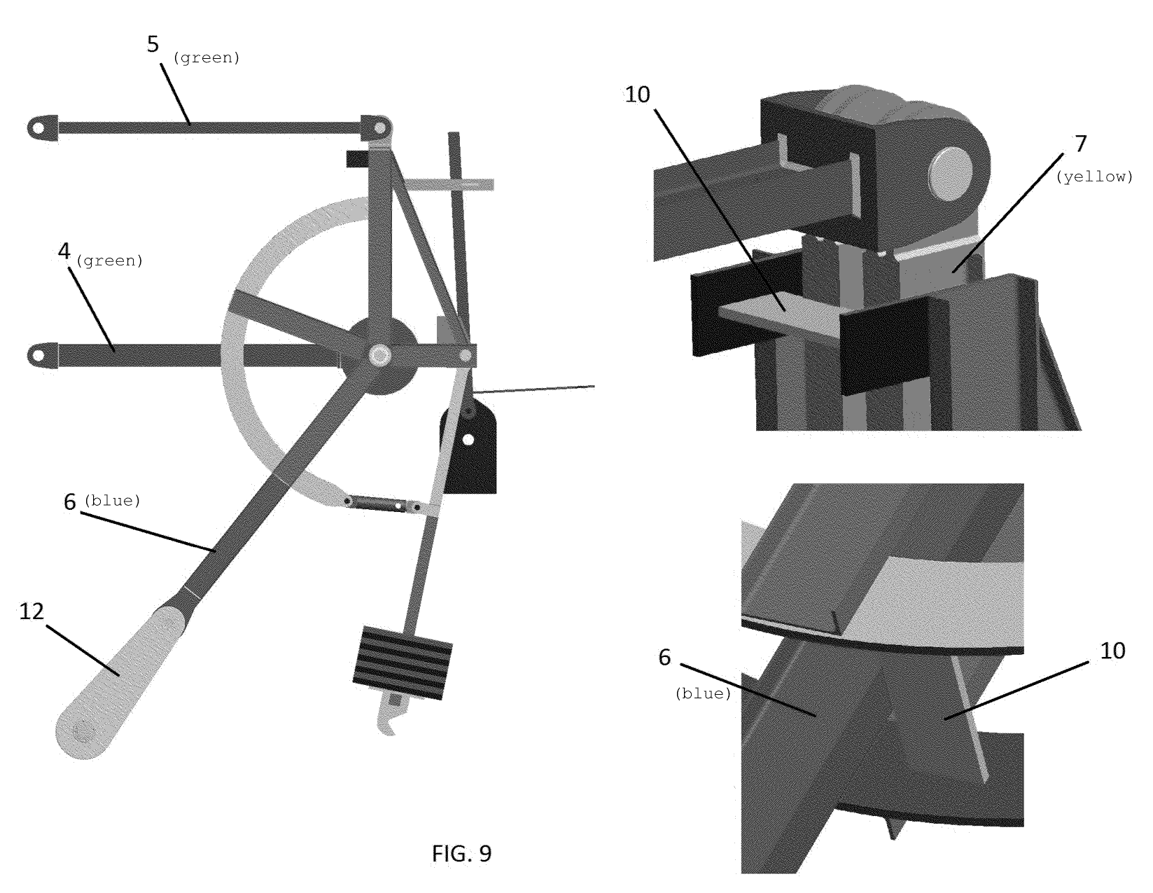

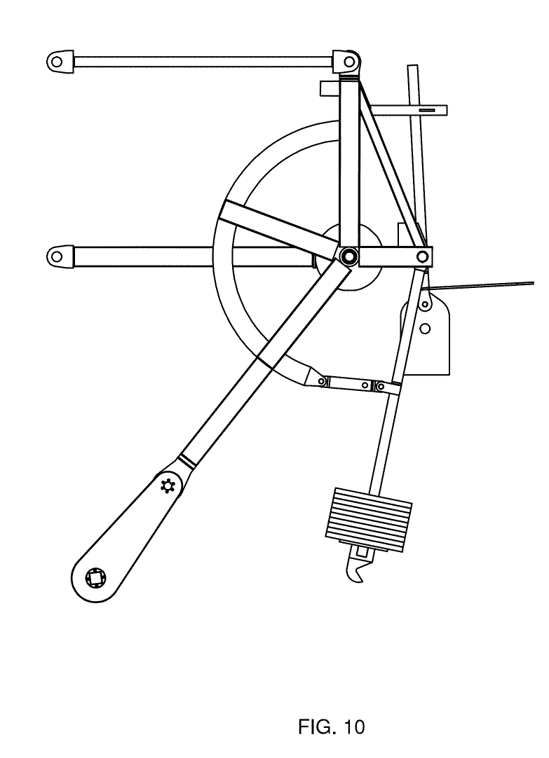

FIGS. 9 and 10 show the position of the weight support bar in the horizontal position horizontal the crankshaft angle that we denominated ZERO and that represents the crankshaft arm aligned with the blue positive bar. This assembly in this position generates a negative force (Anticlockwise) on the crankshaft arm. In this angle zero, the weight support bar is with the lock supported on the yellow neutral bar and the other lock touching the blue positive bar, the telescopic arm is placed with the lock and therefore locked. The second lock of the neutral is placed. During the first moment of motion, the lock supported on the yellow neutral bar moves away from this bar and the weight support bar will then be supported on the blue positive bar.

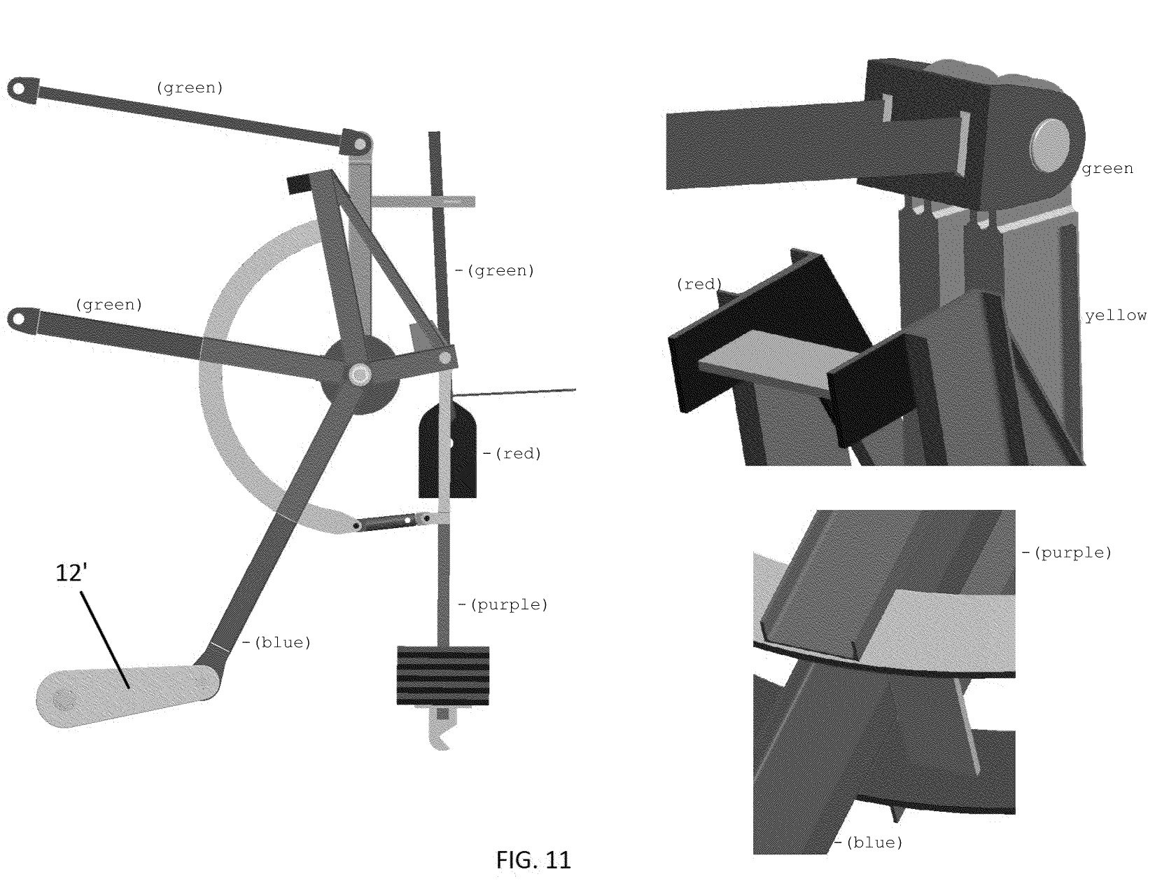

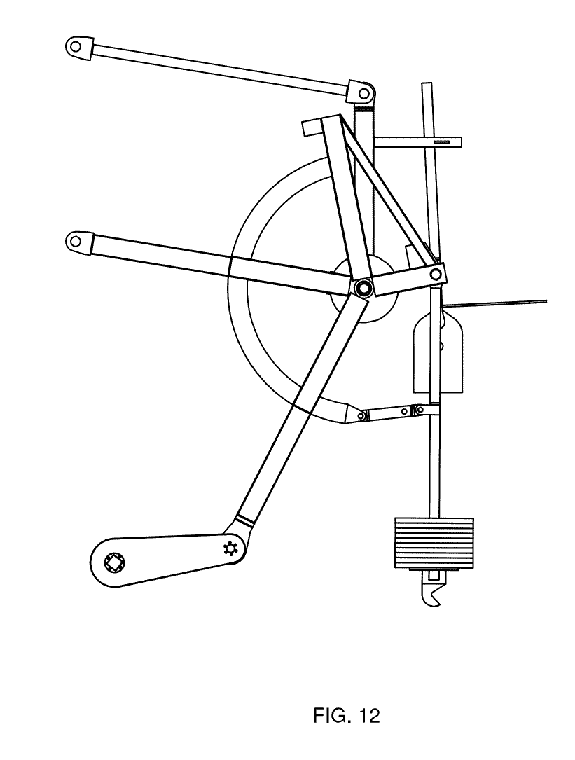

FIGS. 11 and 12 show that at the same time the crankshaft has its arm on angle zero, its next arm will be at an angle of 45 degrees. At this point, the lock of the weight support bar will already be away from the yellow neutral bar and supported on the blue positive bar. This crankshaft arm on angle 45 degrees will already have a small positive force. It is also important to note that the choice of the force path presented above aimed to facilitate the construction of the machine using only two fixed locks. If we use a force path using one or two mobile locks, we would have higher yield.

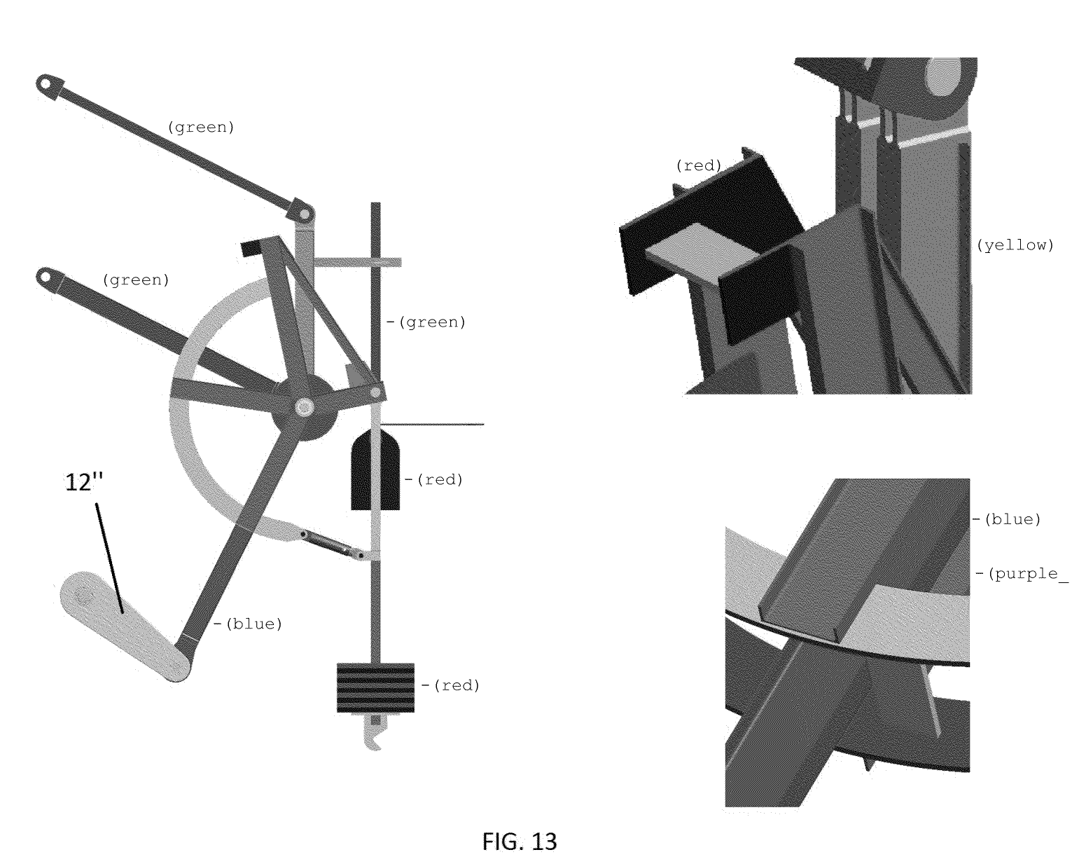

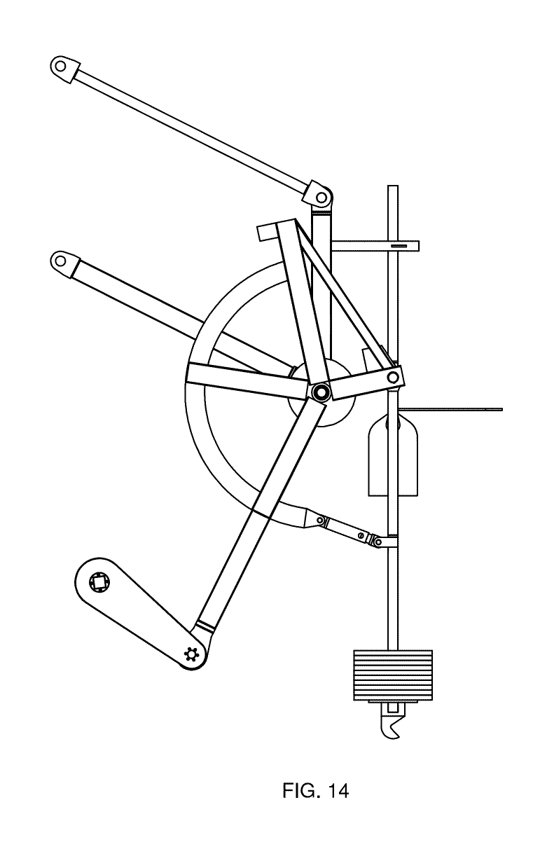

In FIGS. 13 and 14, still with the crankshaft angle on zero degree on the first arm, we can see a third arm in the 90 degrees position. The lock of the weight support bar remains well away from the yellow neutral bar and the other lock remains supported on the blue positive bar. At this point, the force of this crankshaft arm is very strong and positive. When this arm surpasses the angle of 72°, the lock of the telescopic arm is withdrawn, being the weight of the arm in the upright position. Likewise, the second lock is removed from its neutral position and the arm that supports the weight will switch automatically to an upright position. It alone is enough to overcome the negative force of the first arm.

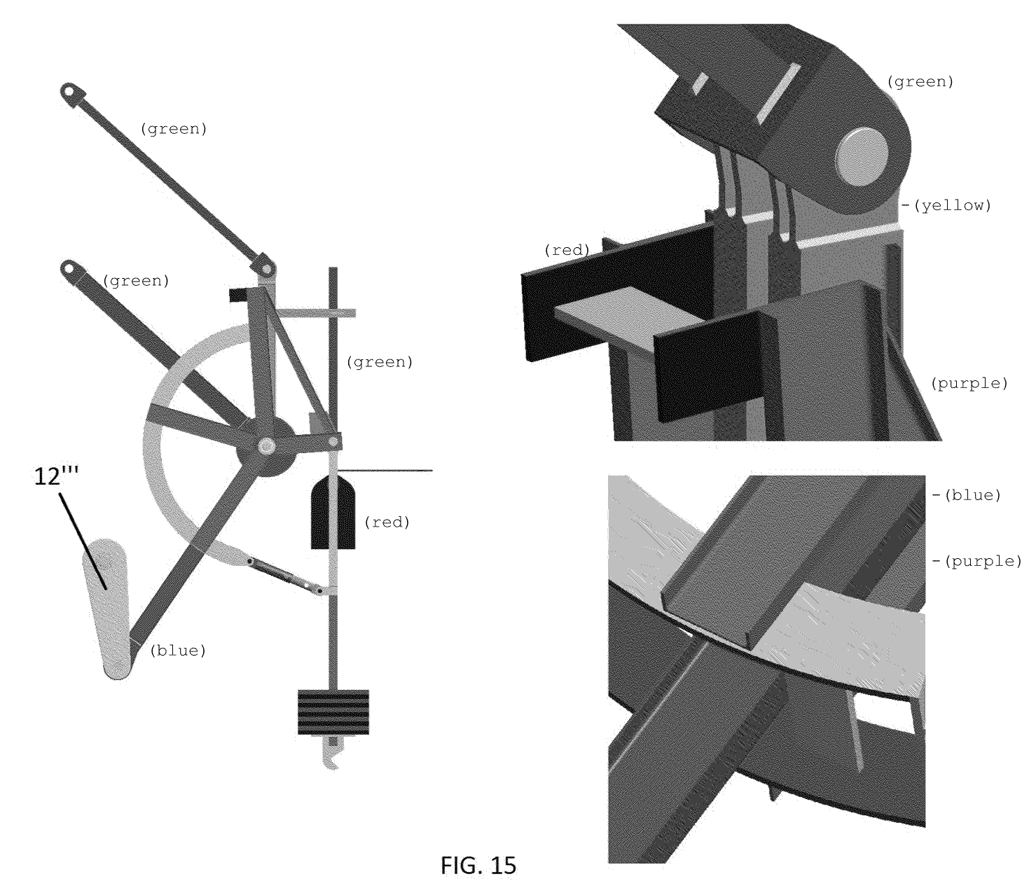

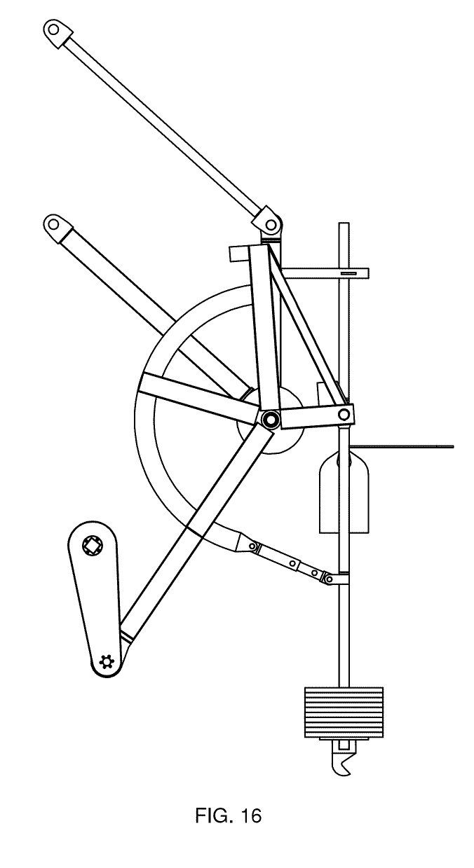

FIGS. 15 and 16 show that a fourth arm is on 135 degrees when the first arm is on the zero point. The lock of the weight support bar now moves close to the yellow neutral bar and the other lock continues to be supported on the blue positive bar. At this point, the force of this arm is very strong and positive.

We then have four crankshaft arms that move in the clockwise direction, driven by the weight that is connected to the weight support bar, which is firmly connected to the arc-locks, and the lock supported on the blue positive bar. These parts in turn are connected to the central shaft that is connected the blue positive bar, which in turn is connected to the crankshaft arm. The forces are then generated in each of these weights and reach the crankshaft. The force of gravity of the weight that reaches the crankshaft on the arm that is on zero degree will generate a negative force (anticlockwise). The force of gravity of the three weights that are in front and reach the crankshaft on the arms that are on 45, 90 and 135 degrees will generate a positive force (clockwise) much higher than the negative force of the first arm at zero degree. Then, the crankshaft when unlocked will immediately turn in the clockwise direction driven by the second, third and fourth arm with forces much higher than the first arm with negative force.

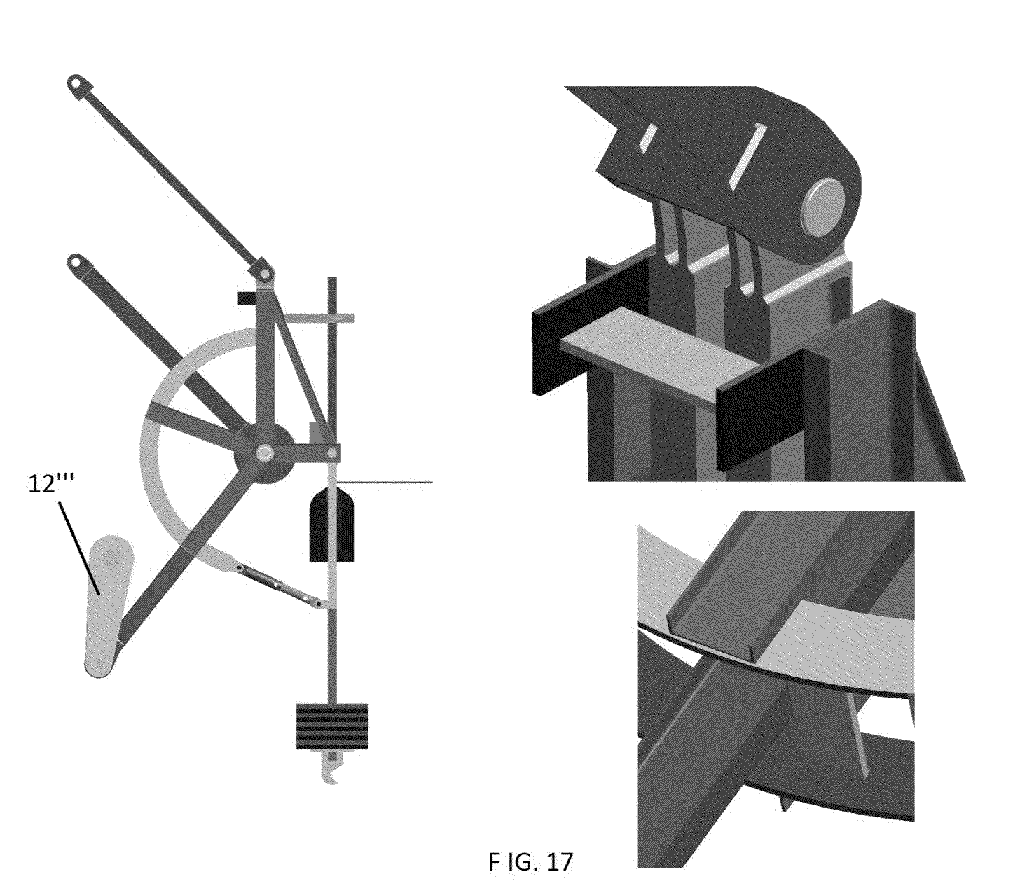

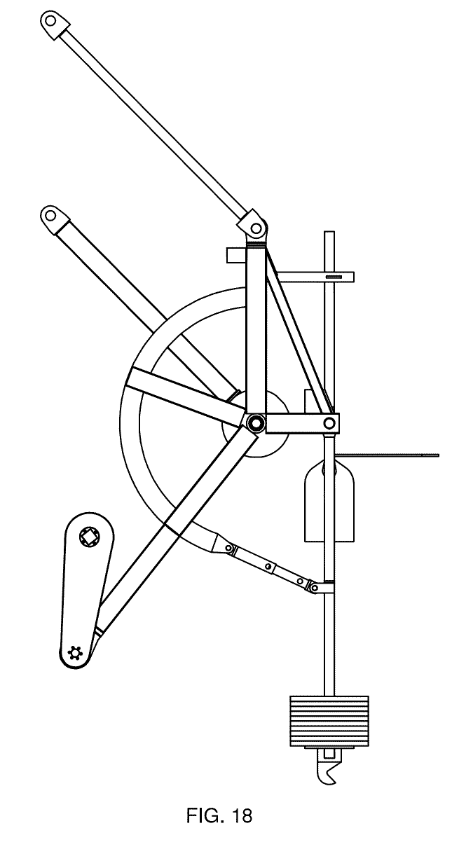

When the crankshaft turns 14 degrees, FIGS. 17 and 18, the fourth arm, which began at 135 degrees reaches 149°, and the yellow bar lock will support itself on the yellow neutral arm again and the other lock that was supported on the blue positive bar will move away and with this, the additional force that exists due to the support of the weight support bar and the weight itself on the blue positive bar will end, that is, the crankshaft arm will continue to be driven by the force of gravity of the weight supported on the yellow neutral bar and will continue until the arm reaches the zero degree position when it will repeat the movement of the crankshaft arm that is initially at zero degree.

In the next 31 degrees of the crankshaft motion, only three crankshaft arms will be receiving the force from the weight support bar and the weigh itself, which will be connected to the blue positive bar. At this point, the force of the first arm at 14 degrees will be less negative and this negativity will continue to decrease in the next degrees. The two other arms will continue with strong positive force.

All the other crankshaft arms, four between angles zero and 14 degrees and five between angles 14 and 45 degrees, will be driven by the force of gravity of the weight support bar and the weight itself with a lock supported on the yellow neutral bar and the other lock away from the blue positive bar. Therefore, there will only be the force of gravity without any increase or addition. I point out that when any of the arms reach position 199°, it will pull over and lean on the tilt control arm of the arm weight, and thus the arm weight will lean to the left to position 273° of the crankshaft, and will reach the initial inclination of 12.7° to the left. At this point the latch is placed on the telescopic arm and the tilt control bar of the arm weight is disconnected. Likewise, when any arm reaches 180°, it is placed the arm that controls the tilt of the weight on the weight on top of it. This weight will return to its original position when the second lock of the yellow neutral bar is replaced.

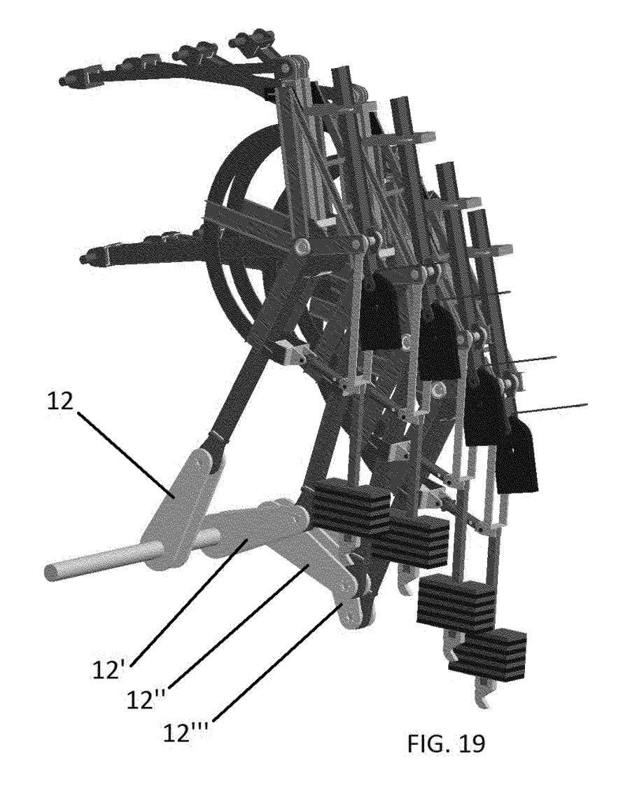

FIG. 19 shows the sequence of the first four arms that are in the initial position of zero, 45, 90 and 135 degrees. Whenever the first arm moves from zero to 45 degrees, another arm will be arriving at the zero degree position. Therefore, we have that at each movement of the crankshaft at 45 degrees, the entire system moves equally to the previous 45 degrees, and with this, the available force becomes permanent, that is, once the equipment is unlocked, it will turn and generate a torque available for use on the crankshaft.

It is important to highlight that the force or intensity of this torque, which will repeat at every 45 degrees, will vary within the 45 degrees motion. Hence, we will have a force intensity at every degree but it will always be positive.

To pair this available force, reducing the lows and highs, I planned the use of two equipments for high generation of energy placed side-by-side and distanced at 22.5 degrees. This method will stabilize the intensity of energy generated.

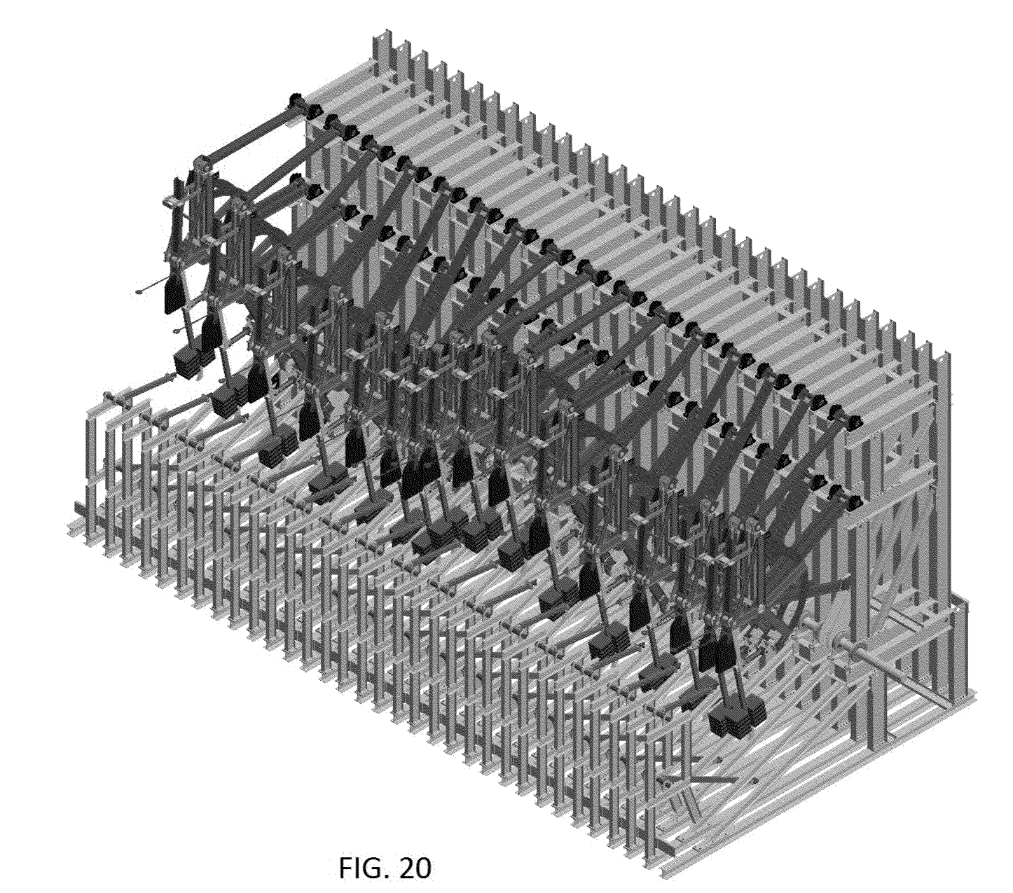

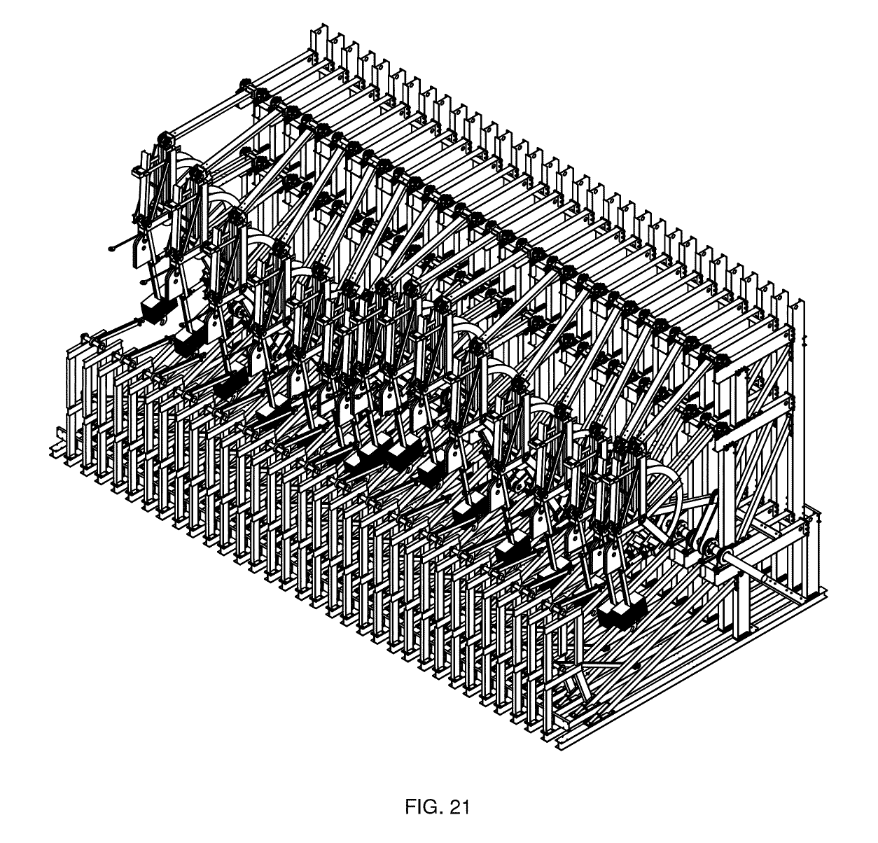

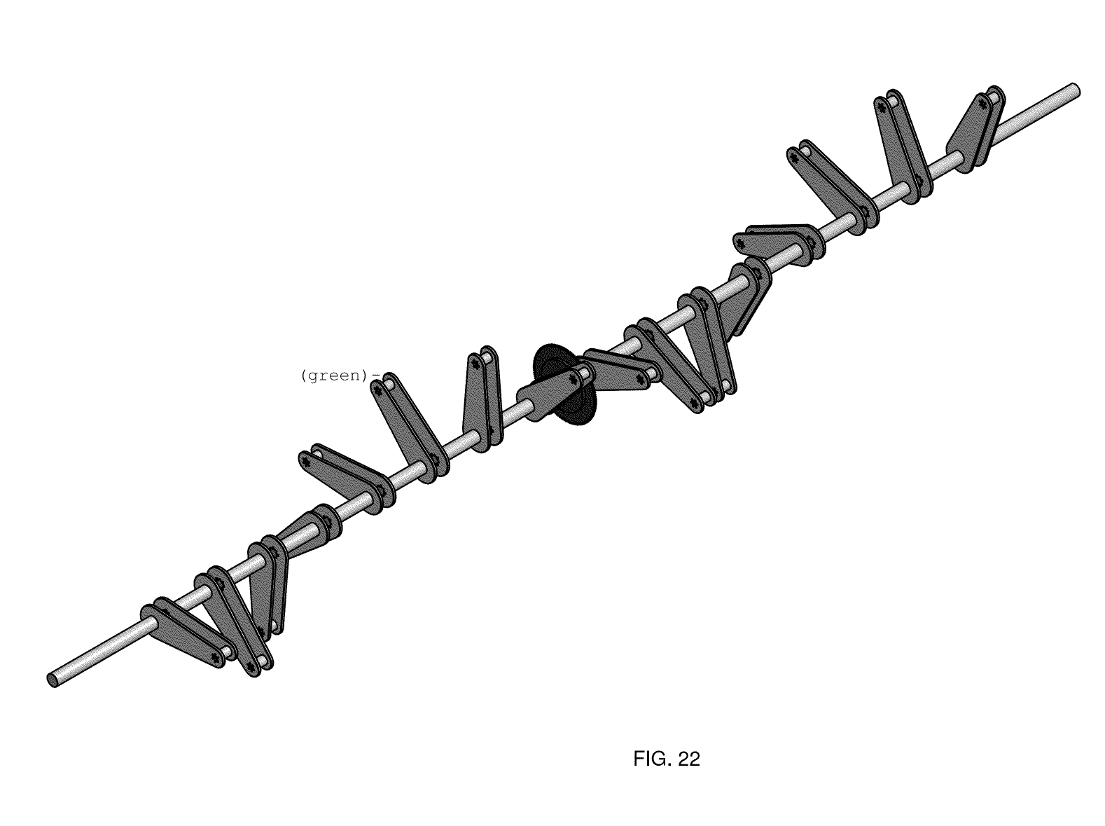

FIGS. 20 and 21 show what a double equipment would be with a stable energy production within every 45 degrees of crankshaft rotation. Therefore, when the first equipment has the first arm on zero degree, the second is has the first arm on 22.5 degrees and so on. In this case, we transmitted the energy from the crankshaft through a gear placed at the center of the two equipments. FIGS. 22 and 13 show that the crankshaft of each equipment have the shafts connected. At this connection point, there is a distance of 22.5 degrees and also a transmission gear of the force.

The industrial application of this equipment is broad and unlimited. The entire world seeks a source of producing energy without pollutants or heat that can destroy the atmosphere. A few days ago, the US president mentioned in his inaugural speech that the US will have the main goal of producing energy with renewable resources. He still has no idea that we will be able to produce energy with resources eternally available at any quantity, at any place or time, without noise, pollution or heat. This invention will certainly promote an industrial and world revolution in the coming decades.

1. Mechanical motion system for energy generation characterized by being exclusively powered by the force or energy of gravity, consisting of an arrangement designed and created with the specific function of enabling the management of the force of gravity existing on the weight (8); where a weight exists (8) connected to a weight support bar (3) and to an arc (9) of locks (10), and this part, in turn, transfers the existing force of gravity to a central shaft (13), with a higher or lower intensity depending on where the lock is supported (10), where this lock can be supported on the neutral bar or on the positive green bar or on the positive blue bar, and this lock (10) will be placed and removed at the convenient time and period and, therefore, the force of gravity will be transferred through the blue bar to the crankshaft arm, which will generate a torque force on its shaft, and the lock will be placed connected to the arc-locks (9) at the convenient place, being driven or removed by a mechanical system, which will be driven by the passing of the assembly through a fixed point of the structure (2).

2. Mechanical motion system for energy generation according to claim 1, characterized by the side by side mounting of the assemblies (1) in a number determined by the distance of the crankshaft arms (12, 12′, 12″, 12′″), which must add up to 360°, and these crankshaft arms receive an impulse from the positive blue bar (6) that is connected to the crankshaft and to the central shaft (13), which, in turn, receives an impulse from the smaller arrangement consisting of the weight (3), and the arc-locks (9), and this force of gravity existing in the central shaft (13) will have a different intensity depending on whether the lock (10) is supported on the blue positive bar (6), on the green positive bar (4), or on the yellow neutral bar (7), where these bars are also connected to the central shaft (13), and the yellow neutral bar (7) is connected to a second green positive bar (5), and these two green positive bars (4,5) are connected to a fixed support structure (2) in a way that the yellow neutral bar (7) always remains in the vertical position during the motion of the crankshaft.

3. Mechanical motion system for energy generation according to claim 1, characterized by the system of locks (10) that are driven or removed at the convenient time during crankshaft motion and from the entire arrangement, and these locks (10) have the specific function of determining the path of the force that passes from the weight (8) to the crankshaft (11), and, depending on the choice of where these locks (10) are supported, which can be on the positive blue bar (6), green positive bar (4), on telescopic arm (10-A) or neutral bar (7), and how long it remains supported on each of these bars, during a crankshaft movement 360°, a change will be generated in the intensity of the force of gravity that arrives at the crankshaft and where the torque is applied, and the difference in forces will be proportional to the length of the blue or green positive bars in relation to the length of the weight support bar (3).

4. Mechanical motion system for energy generation according to claim 1, 2 or 3, characterized by the fact that the arrangements mentioned above have angles between the crankshaft arm and the positive blue bar (6) and this, in turn, with the green positive bar, the yellow neutral bar with the weight support weight support bar and also with the horizontal and vertical lines, which are chosen with the purpose of improving the yield of the operation.

5. Mechanical motion system for energy generation according to claim 1, 2, or 3, characterized by the fact that changes in the dimension of the machine for more, such as crankshaft (11) radius, the length of the arms, the size of the weights will increase or decrease the additional power, while the measures presented solely for the model construction and for better understanding of this application.

6. Mechanical motion system for energy generation according to claim 4, characterized by the fact that changes in the dimension of the machine for more, such as crankshaft (11) radius, the length of the arms, the size of the weights will increase or decrease the additional power, while the measures presented solely for the model construction and for better understanding of this application.
